(19) United States
(12) Patent Application Publication
(10) Pub. No.: US 2025/0031157 A1
(43) Pub. Date: Jan. 23, 2025

(54) ELECTRONIC DEVICE COMPRISING ANTENNA AND METHOD THEREFOR

(71) Applicant: Samsung Electronics Co., Ltd., Suwon-si (KR)

(72) Inventors: Kyujae JANG, Suwon-si (KR); Jaemoon CHA, Suwon-si (KR); Dohun KIM, Suwon-si (KR); Jaegon GHIM, Suwon-si (KR); Jimin KOO, Suwon-si (KR); Sungyoul CHO, Suwon-si (KR)

(21) Appl. No.: 18/904,507

(22) Filed: Oct. 2, 2024

Related U.S. Application Data
(63) Continuation of application No. PCT/KR2023/005673, filed on Apr. 26, 2023.

(30) Foreign Application Priority Data
May 26, 2022 (KR) 10-2022-0064985
Aug. 18, 2022 (KR) 10-2022-0103490

(51) Int. Cl. H04W 52/36; H04W 4/38; H04W 24/08; H04W 52/22; H04W 76/20

(52) U.S. Cl. CPC H04W 52/367; H04W 4/38; H04W 24/08; H04W 52/225; H04W 76/20

(57) ABSTRACT

The present disclosure relates to an apparatus and a method for controlling power consumption for monitoring a sensor state in an electronic device. The electronic device can stop checking the state of at least one sensor until a radio resource control (RRC) connection is maintained, and a cumulative electromagnetic wave specific absorption rate (SAR) reaches a preset threshold value (SAR_threshold). The cumulative electromagnetic wave specific absorption rate may be an electromagnetic wave specific absorption rate accumulated by transmission power transmitted within a time period corresponding to a time slot using a specific frequency band.

### CROSS-REFERENCE TO RELATED APPLICATIONS

This application is a continuation of International Application No. PCT/KR2023/005673designating the United States, filed on Apr. 26, 2023, in the Korean Intellectual Property Receiving Office and claiming priority to Korean Patent Application Nos. 10-2022-0064985, filed on May 26, 2022, and 10-2022-0103490, filed on Aug. 18, 2022, in the Korean Intellectual Property Office, the disclosures of each of which are incorporated by reference herein in their entireties.

### BACKGROUND

### Field

The disclosure relates to a device and method for controlling power consumption in an electronic device including an antenna.

### Description of Related Art

A personal electronic device (hereinafter referred to as an ‘electronic device’), such as a portable communication device (e.g., a smartphone), a tablet personal computer (tablet PC), an e-book, or a laptop, may be carried in the user's hand or a pouch.

The electronic device may generate electromagnetic waves which are invisible. The electronic device may generate relatively large amounts of electromagnetic waves when performing wireless communication. When the electromagnetic waves are absorbed by humans, they may have adverse effects on the human body.

For this reason, specific absorption rate (SAR) standards are being prepared nationwide and worldwide. The SAR standard specifies in numbers the amount of electromagnetic waves generated when using electronic devices that may be absorbed by the body of a person or animal. The SAR is the amount of electromagnetic wave energy absorbed by a unit mass (1 kg or 1 g) of the human body per unit time, and may be used in W/kg or mW/g.

When the human body is exposed to electromagnetic waves of a low frequency (1 Hz to 100 kHz), the current induced in the human body may stimulate (stimulation action) the nerves. When the human body is exposed to electromagnetic waves of a high frequency (100 kHz˜10 GHz), a thermal action that increases the body temperature may occur in the human body. For example, electromagnetic waves generated from electronic devices have a high frequency and may cause body temperature to rise. This thermal action may be expressed quantitatively, an example of which may be SAR. For example, in some countries, such as Korea (KR) or the United States (US), a strict limit of 1.6 W/kg is set, which is lower than the internationally recommended standard of 2 W/kg. The safety standard of 1.6 W/kg is set 50 times more strictly than the expected risk level. For this reason, it is recommended that SAR measurements for electronic devices meet the human protection standards.

### SUMMARY

Embodiments of the disclosure provide a device and method for controlling power consumption for sensor monitoring considering the SAR in an electronic device.

Embodiments of the disclosure provide a device and method for controlling transmission power of an antenna based on an SAR margin in an electronic device.

According to an example embodiment of the disclosure, an electronic device may comprise: a communication module comprising communication circuitry configured to perform wireless communication, a sensor module including at least one sensor configured to detect a state related to the electronic device and generate sensor monitoring information corresponding to the detected state, and at least one processor, comprising processing circuitry, electrically connected to the communication module and/or the sensor module and configured to: control power consumption in the electronic device; based on a radio resource control (RRC) connection with an external electronic device being maintained by the communication module, stop state identification for at least one sensor until a cumulative specific absorption rate (SAR) reaches a specified threshold (SAR_threshold); wherein the cumulative specific absorption rate may be a specific absorption rate accumulated by transmission power transmitted within a time interval corresponding to a time slot using a specific frequency band.

According to an example embodiment of the disclosure, a method for controlling power consumption in an electronic device may comprise: based on a radio resource control (RRC) connection being maintained, stopping state identification for at least one sensor until a cumulative specific absorption rate (SAR) reaches a specified threshold (SAR_threshold), wherein the cumulative specific absorption rate may be a specific absorption rate accumulated by transmission power transmitted within a time interval corresponding to a time slot using a specific frequency band.

According to various example embodiments of the disclosure, it is possible to save current consumed in a sensor monitoring operation by adaptively performing the sensor monitoring operation considering whether SAR is required due to wireless communication and whether the SAR margin is sufficient or roomy in an electronic device.

Effects achievable by various example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from various example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration for managing transmission power considering a specific absorption rate (SAR) in an electronic device according to various embodiments;

FIG. 3 is a state transition diagram illustrating an example of managing transmission power considering a specific absorption rate (SAR) in an electronic device according to various embodiments;

FIG. 4 is a flowchart illustrating example operations for controlling power consumption in an electronic device according to various embodiments;

FIG. 5 is a flowchart illustrating a subroutine for an example operation in a frequency band not requiring specific absorption rate (SAR) backoff in an electronic device according to various embodiments;

FIG. 6 is a flowchart illustrating a subroutine for an example operation in a frequency band requiring specific absorption rate (SAR) backoff in an electronic device according to various embodiments;

FIG. 7 is a graph illustrating a current amount consumed to perform periodic sensor monitoring in an electronic device according to various embodiments;

FIG. 8 is a graph illustrating a relationship between parameters for managing a specific absorption rate (SAR) margin in an electronic device according to various embodiments; and

FIG. 9 is a signal flow diagram illustrating an example signal processing procedure for monitoring a sensor state in an electronic device according to various embodiments.

In connection with the description of the drawings, the same or similar reference numerals may be used to denote the same or similar elements.

### DETAILED DESCRIPTION

Hereinafter, various example embodiments of the disclosure are described in greater detail with reference to the drawings. However, the disclosure may be implemented in other various forms and is not limited to the various example embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

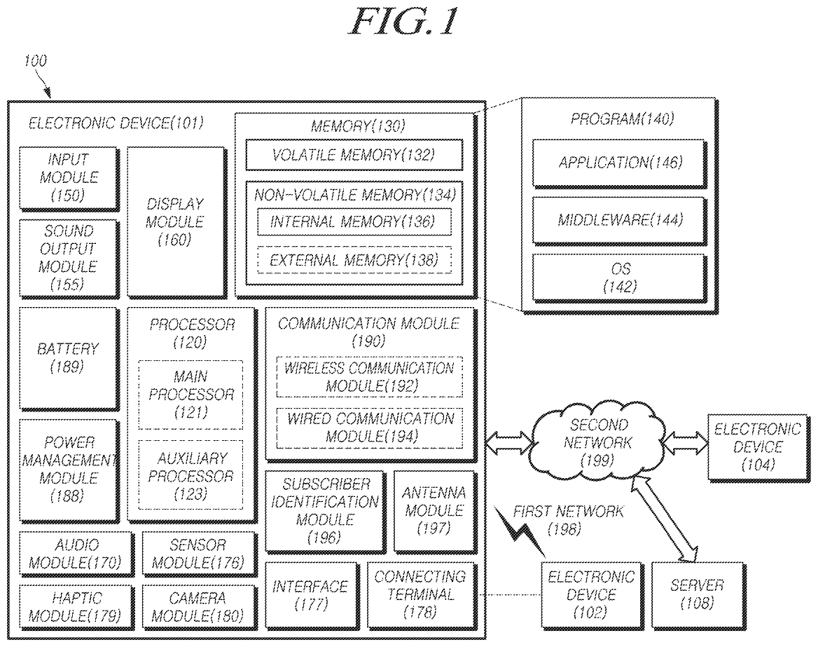

FIG. 1 is a block diagram illustrating an example electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

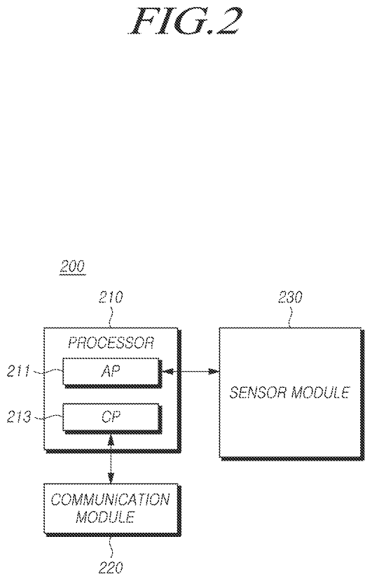

FIG. 2 is a block diagram illustrating an example configuration for managing transmission power considering an SAR in an electronic device 200 (e.g., the electronic device 101 of FIG. 1) according to various embodiments.

Referring to FIG. 2, in an embodiment, the electronic device 200 may include a processor (e.g., including processing circuitry) 210 (e.g., the processor 120 of FIG. 1), a communication module (e.g., including communication circuitry) 220 (e.g., the communication module 190 of FIG. 1), and/or a sensor module (e.g., including at least one sensor) 230 (e.g., the sensor module 176 of FIG. 1) as components for managing transmission power considering SAR. The processor 210 may include one or a plurality of processors. The processor 210 may include, e.g., an application processor (AP) 211 (e.g., the main processor 121 of FIG. 1) or a communication processor (CP) 213 (e.g., the auxiliary processor 123 of FIG. 1). The processor 210 (including the AP 211 and the CP 213) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The CP 213 may include various processing circuitry and control an overall operation for communication performed by the electronic device 200. The CP 213 may establish an RRC connection with an electronic device (e.g., a base station) provided in a network (e.g., the second network 199 of FIG. 1) using, e.g., a radio resource control (RRC) message. The RRC connection establishment may include, e.g., an operation in which a state transition is performed from the RRC release state to the RRC connected state. When the RRC connection is established, the CP 213 may be allocated uplink and/or downlink radio resources from the base station to monitor a control channel of the base station, transmit or receive data. When the RRC connection is established, the CP 213 may report various measurement information such as channel state, security management, and traffic management to the base station, or may perform a handover procedure considering channel state or traffic speed dominantly in the network 199. The RRC connection may refer, for example, to transmission power existing. When there is no work for a certain period of time or an event such as blocking data occurs, the CP 213 may reset or release the RRC connection using an RRC message. The release of the RRC connection may refer, for example, to there being no transmission power.

According to an embodiment, when the RRC connection is established, the CP 213 may selectively transmit a request message (SAR Event Request) requesting sensor monitoring to the AP 211 considering whether SAR backoff is required or SAR margin is sufficient. The CP 213 may selectively transmit a request message (SAR Event Request) requesting sensor monitoring to the AP 211 considering whether SAR backoff is required or SAR margin is sufficient even during RRC connection. In an embodiment, the CP 213 may selectively transmit a request message (SAR Event Request) requesting sensor monitoring to the AP 211 considering whether SAR backoff is required or SAR margin is sufficient, even when a transmission signal is transmitted through a random access channel (RACH) in a state where RRC connection is not performed (RRC release). The SAR backoff may refer, for example, to the SAR being expected to exceed a limit level, and thus, transmission power being systematically controlled to avoid the same. The frequency band requiring SAR backoff refers to a frequency band requiring systematic control and reduction of transmission power when SAR is expected to exceed the limit level. The frequency band requiring the SAR backoff may be, e.g., a frequency band higher than a predetermined threshold frequency band. The frequency band not requiring the SAR backoff refers to a frequency band in which it is not necessary to systematically control and reduce transmission power even if the SAR is expected to exceed the limit level. The frequency band not requiring the SAR backoff may be, e.g., a frequency band lower than the predetermined threshold frequency band.

The CP 213 may determine, e.g., whether SAR backoff is required based on the operating frequency band. The SAR request message (SAR Event Request) may be a message requesting sensor monitoring from the AP 211. When the request message (SAR Event Request) is not transmitted to the AP 211 by the CP 213, the AP 211 may not wake up. In this case, current consumption for waking up the AP 211 may not occur.

For example, the CP 213 may determine that the SAR backoff is not required when it is predicted that the SAR standard may be met, even if it operates with the maximum transmission power that the electronic device 200 may use during one time slot using the operating frequency band. The CP 213 may determine that the SAR backoff is not required when operating in a frequency band (e.g., a low frequency band) in which the minimum Pₗᵢₘᵢₜ (P_{limit.min}) among the Pₗᵢₘᵢₜ's for each device state index (DSI) exceeds the maximum transmission power Pₘₐₓ (P_{limit.min}>Pₘₐₓ) that may be used while meeting the SAR standard in the electronic device 200. For example, when an RRC connection is established with a serving cell or a serving base station in a frequency band that meets a condition that does not require SAR backoff (P_{limit.min}>Pₘₐₓ), the CP 213 may not transmit a request message (SAR Event Request) to the AP 211.

The CP 213 may continuously identify the SAR margin even after determining that the SAR backoff is not required. If the SAR margin is larger than or equal to a threshold level (e.g., 70% of the total SAR margin), the CP 213 may determine that the SAR margin is sufficient or roomy and may not continuously transmit the request message (SAR Event Request) to the AP 211. When the SAR margin falls below a threshold level, the CP 213 may determine that the SAR margin needs to be managed to meet the SAR standard and transmit a request message (SAR Event Request) to the AP 211. The case where the SAR margin falls below the threshold level may correspond to, e.g., a case where the electronic device 200 performs handover in a serving cell or a serving base station in which SAR consumption is excessive.

If it is predicted that the SAR standard may not be met when the CP 213 operates with the maximum transmission power available to the electronic device 200 during one time slot using the operating frequency band, the CP 213 may determine that the SAR backoff is required. The CP 213 may determine that the SAR backoff is required when operating in a frequency band (e.g., an intermediate frequency or high frequency band) in which the minimum Pₗᵢₘᵢₜ (P_{limit.min}) among the Pₗᵢₘᵢₜ's for each DSI is equal to or lower than the maximum transmission power Pₘₐₓ (P_{limit.min}≤Pₘₐₓ) that may be used while meeting the SAR standard in the electronic device 200.

The CP 213 may continuously check the first SAR margin (e.g., 1^{st} SAR_Margin) after determining that the SAR backoff is necessary. When the first SAR margin falls below a first threshold level (1^{st} SAR_Margin<1^{st} Threshold), the CP 213 may determine that the SAR margin needs to be managed to meet the SAR standard and transmit a request message (SAR Event Request) to the AP 211. The case where the first SAR margin falls below the first threshold level may correspond to, e.g., a case where SAR consumption in the electronic device 200 is excessive. If the first SAR margin is equal to or larger than the first threshold level (1^{st} Threshold) (e.g., 70% of the total SAR margin) (1^{st} SAR_Margin≥1^{st} Threshold), the CP 213 may determine that the SAR margin is sufficient or roomy and thus may not transmit a request message (SAR Event Request) to the AP 211. If the first SAR margin is equal to or larger than the first threshold level (1^{st} SAR_Margin42 1^{st} Threshold), the CP 213 may operate based on the minimum average power limit (min.Pₗᵢₘᵢₜ) during the SAR event. Even when operating based on the minimum average power limit (min. Pₗᵢₘᵢₜ) during the SAR event, the CP 213 may continuously identify the second SAR margin (e.g., 2^{nd} SAR_Margin). If the second SAR margin is equal to or larger than the second threshold level (2^{nd} Threshold) (2^{nd} SAR_Margin≥2^{nd} Threshold), the CP 213 may determine that the SAR margin is sufficient or roomy and thus may continuously stop transmitting a request mg (SAR Event Request) to the AP 211. When the second SAR margin falls below a second threshold level (2^{nd} SAR_Margin<2^{nd} Threshold), the CP 213 may determine that the SAR margin needs to be managed to meet the SAR standard and transmit a request message (SAR Event Request) to the AP 211. The case where the second SAR margin falls below the second threshold level may correspond to, e.g., a case where SAR consumption in the electronic device 200 is excessive.

The CP 213 may receive a response message (SAR Event Response or DSI Status Response) including information about the sensor state from the AP 211 in response to a request message (SAR Event Request or DSI Status Request). The CP 213 may change the SAR state based on the sensor state information (DSI) included in the received response message (SAR Event Response or DSI Status Response). The AP 211 may transfer the sensor state information DSI to the CP 213 without passing through the SAR Event Response. In an embodiment, the AP 211 may directly transfer sensor state information (DSI) to the CP 213. In this case, the CP 213 may transmit the “DSI Status Request” to the AP 211 as a request message. In the disclosure, for convenience of explanation, “Event Request” or “DSI Status Request” is collectively referred to as one of a request message, a request message (SAR Event Request) or an SAR Event Request.

The sensor state information (DSI) may be, e.g., sensing information about a sensor related to a universal serial bus (USB), grip, proxy, or near, or information about a state change of a device such as a liquid crystal display (LCD). The information about the state change of the USB may be sensing information indicating a state of whether a cable for charging or data sharing is mounted on the USB port. The information about the state change of the grip may be sensing information sensed by the grip sensor according to whether the user grips the electronic device 200 and/or the form of the gripping hand. The information about the state change of the proxy may be sensing information about the change in an operating subject performing a specific function. The information about the state change of proximity may be sensing information sensed by a proximity sensor due to an interval between the electronic device 200 gripped by the user and the body. The information about the state change of the LCD may be information indicating the operation state of the display. The information indicating the operation state of the display may include, e.g., information indicating a power saving state such as a screen off or a minimum activation state (e.g., always on display (AOD)). The change in the SAR state may be, e.g., a change of maximum transmit power level (MTPL).

According to an embodiment, the AP 211 may include various processing circuitry and may wake up at the request of the CP 213 (SAR Event Request) and activates the sensor module 230 to periodically monitor the sensor response. The AP 211 may transfer sensor state information (DSI) obtained through periodic monitoring to the CP 213. The AP 211 may disable the sensor 2113 by a stop request (SAR Event Stop) from the CP 213 to stop the operation of monitoring the sensor state.

According to an embodiment, the communication module 220 may include various communication circuitry and communicate with at least one of an electronic device (e.g., the electronic device 102 or the electronic device 104 of FIG. 1) or a server (e.g., the server 108 of FIG. 1) through a network (e.g., the first network 198 or the second network 199) under the control of the CP 213. For convenience of description below, the communication module 220 is assumed to communicate with the electronic device 104 through the second network 199, which may be a long-range wireless communication network.

When the communication module 220 performs communication with the electronic device 104 through the second network 199, the communication module 220 may transmit or receive wireless signals. The communication module 220 may radiate wireless signals to the second network 199 by predetermined transmission power. In an embodiment, the transmission power of the communication module 220 may be managed or controlled by the CP 213. For example, the transmission power of the communication module 220 may be changed by the control of the CP 213 considering whether the SAR backoff is required or whether the SAR margin is sufficient.

As an embodiment, the sensor module 230 may include at least one sensor and detect an operation state of the electronic device 200 (e.g., an operation state of the display, a peripheral illuminance state, a power use state, or a temperature state), or an external environment state (e.g., a user grip state or a proximity state), and generate an electrical signal or data value corresponding to the detected state. When a state change occurs after being activated under the control of the AP 211, the sensor module 230 may report the state change information to the AP 211. The sensor module 230 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor. At least one sensor included in the sensor module 230 may provide sensor monitoring information according to state changes to the AP 211 under the control of the AP 211 to the AP 211 in response to periodic or event occurrences.

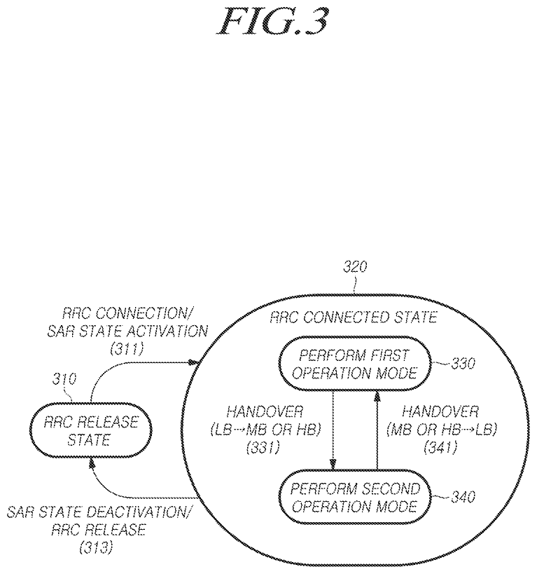

FIG. 3 is a state transition diagram illustrating an example configuration for managing transmission power considering an SAR in an electronic device (e.g., the electronic device 200 of FIG. 2) according to various embodiments.

Referring to FIG. 3, an RRC state in the electronic device 200 may include an RRC release state (or an RRC idle state) 310 of being not connected to an electronic device (e.g., a base station or a serving cell) provided in a network (e.g., the second network 199 of FIG. 1) or an RRC connected state 320 of being connected via RRC. When the RRC connection with the base station (or the serving cell) is established, the electronic device 200 may transition from the RRC release state 310 to the RRC connected state 320 (operation 311). When the state transitions to the RRC connected state 320, the electronic device 200 may activate the SAR state. Activation of the SAR state may be understood as operating a function of managing SAR consumption to meet the SAR standard. When the RRC connection with the base station is released, the electronic device 200 may transition from the RRC connected state 320 to the RRC release state 310 (operation 313). When the state transitions to the RRC release state 310, the electronic device 200 may deactivate the SAR state. Deactivation of the SAR state may be understood as terminating the function of managing SAR consumption to meet the SAR standard.

In an embodiment, the electronic device 200 may perform an operation according to one of the first operation mode 330 or the second operation mode 340 in the RRC connected state.

The first operation mode 330 defines, e.g., an operation of not performing a sensor monitoring operation when it is predicted to meet the SAR standard. In this case, current consumption due to sensor monitoring may not occur or may be reduced. For example, in the first operation mode 330, when communication is expected to be performed to meet the SAR standard during one time slot, the electronic device 200 may prevent and/or block the CP (e.g., the CP 213 of FIG. 2) from requesting sensor monitoring from the AP (e.g., the AP 211 of FIG. 2). In this case, since the AP 211 and/or one or more sensors are not required to wake up for sensor monitoring, current consumption due to sensor monitoring may be reduced.

The second operation mode 340 defines an operation that allows sensor monitoring to be performed when it is predicted that the SAR standard is not met. In this case, current consumption may occur due to sensor monitoring. For example, in the second operation mode 340, the electronic device 200 may allow the CP 213 to request sensor monitoring from the AP 211. In this case, the AP 211 may wake up for sensor monitoring and activate one or more sensors for sensor monitoring. The activated one or more sensors may transfer a monitoring result for the state change to the AP 211. The AP 211 may collect the monitoring result for the state change and transfer the monitoring result to the CP 213. In this case, current consumption for waking up the AP 211 and activating one or more sensors may occur. A few mA of current may be periodically consumed, e.g., to keep the AP 211 awake and, to keep the AP 211 awake and perform state change monitoring by the sensor (e.g., the sensor module 230 of FIG. 2), tens to hundreds of mA may be periodically consumed.

According to an embodiment, when a preset first condition is met in performing the first operation mode 330, the electronic device 200 may not wake up the AP 211 for sensor monitoring. The preset first condition may be a condition in which it is determined that SAR backoff is not required and SAR margin is sufficient (e.g., SAR_Margin>SAR_threshold). The electronic device 200 may determine that SAR backoff is not required when communicating using a frequency band (e.g., a low frequency band) having a low SAR value. For example, when Pₗᵢₘᵢₜ exceeds Pₘₐₓ (Pₗᵢₘᵢₜ>Pₘₐₓ), the electronic device 200 may determine that it is a low frequency band not requiring the SAR backoff. Pₗᵢₘᵢₜ may be a transmission power level matching a SAR design target. For example, when the SAR design target is “SAR 1 W/kg”, the Pₗᵢₘᵢₜ may be 20 dBm. Pₘₐₓ may be a maximum transmission power level that the electronic device 200 may output. The fact that Pₗᵢₘᵢₜ exceeds Pₘₐₓ (Pₗᵢₘᵢₜ>Pₘₐₓ) may serve as a basis for predicting that the electronic device 200 does not exceed the SAR design target even if the electronic device 200 operates for one time slot (1 time slot) (FDD band of 6 GHz or less is 100 seconds) predefined as the maximum transmission power level.

The electronic device 200 may wake up the AP 211 for sensor monitoring in the first operation mode 330. For example, when it is determined that the SAR backoff is not required but the SAR margin is not sufficient (e.g., SAR_Margins≤SAR_threshold), the electronic device 200 may perform a sensor monitoring operation. In order to perform the sensor monitoring operation, the CP 213 may wake the AP 211. The awakened AP 211 may activate one or more sensors to perform sensor monitoring. As a case where the SAR margin is determined to be insufficient (e.g., SAR_Margin≤SAR_threshold), e.g., a case where the electronic device 200 consumes much of the SAR margin in a base station (or cell) using a frequency band (e.g., an intermediate frequency band or a high frequency band) having a high SAR, and then moves (e.g., handover) to a base station (or cell) using a frequency band (e.g., a low frequency band) having a low SAR value may be assumed (operation 341).

In an embodiment, when a preset second condition is met in the second operation mode 340, the electronic device 200 may wake up the AP 211 for sensor monitoring. The preset second condition may be, e.g., a condition in which SAR backoff is required and SAR margin is not sufficient (e.g., 1^{st} SAR Margin<1^{st} Threshold or 2^{nd} SAR Margin<2^{nd} Threshold). The determination as to whether the preset second condition is met may be equally applied when the electronic device 200 in the first operation mode 330 transitions to the second operation mode 340. The state transition from the first operation mode 330 to the second operation mode 340 may be performed, e.g., when the electronic device 200 moves (e.g., handover) from a base station (or cell) using a frequency band (e.g., a low frequency band) having a low SAR value to a base station (or cell) using a frequency band (e.g., an intermediate frequency band or a high frequency band) having a high SAR value (operation 331). The electronic device 200 may determine that an SAR backoff is required when communicating using a frequency band (e.g., an intermediate frequency band or a high frequency band) having a high SAR value. For example, when Pₗᵢₘᵢₜ is equal to or smaller than Pₘₐₓ (Pₗᵢₘᵢₜ≤Pₘₐₓ), the electronic device 200 may determine that it is an intermediate or high frequency band requiring the SAR backoff. Pₗᵢₘᵢₜ may be a transmission power level matching a SAR design target. For example, when the SAR design target is “SAR 1 W/kg”, the Pₗᵢₘᵢₜ may be 20 dBm. Pₘₐₓ may be a maximum transmission power level that the electronic device 200 may output. That Pₗᵢₘᵢₜ is equal to or smaller than Pₘₐₓ (Pₗᵢₘᵢₜ≤Pₘₐₓ) may serve as a basis for predicting that the electronic device 200 may exceed the SAR design target when the electronic device 200 operates for one time slot (1 time slot) (FDD band of 6 GHz or less is 100 seconds) predefined as the maximum transmission power level.

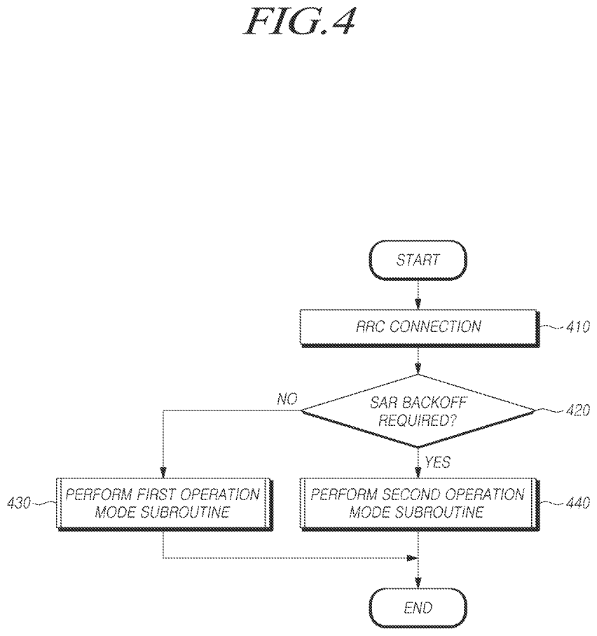

FIG. 4 is a flowchart illustrating example operations for controlling power consumption in an electronic device (e.g., the electronic device 200 of FIG. 2) according to various embodiments.

Referring to FIG. 4, in operation 410, the electronic device 200 may establish an RRC connection with an electronic device (e.g., a base station or a serving cell) provided in a network (e.g., the second network 199 of FIG. 1). For example, if the RRC connection with the base station (or the serving cell) is established, the electronic device 200 may transition from the RRC release state (or RRC idle state) (e.g., the RRC release state 310 of FIG. 3) of not being RRC-connected with the base station (or cell) to the RRC connected state 320 of being RRC-connected. When the state transitions to the RRC connected state 320, the electronic device 200 may activate the SAR state.

In operation 420, the electronic device 200 may determine whether SAR backoff is required. The electronic device 200 may determine, e.g., that SAR backoff is not required when SAR communicates using a low frequency band (e.g., a low frequency band). For example, when communicating using a low frequency band not requiring SAR backoff, it may be general that Pₗᵢₘᵢₜ exceeds Pₘₐₓ (Pₗᵢₘᵢₜ>Pₘₐₓ). Accordingly, when Pₗᵢₘᵢₜ exceeds Pₘₐₓ (Pₗᵢₘᵢₜ>Pₘₐₓ), the electronic device 200 may determine that it communicates with the base station (or cell) using a low frequency band not requiring the SAR backoff. For example, the electronic device 200 may determine that an SAR backoff is required when communicating using a frequency band (e.g., an intermediate frequency band or a high frequency band) having a high SAR value. For example, when communicating using an intermediate or high frequency band requiring SAR backoff, it may be general that Pₗᵢₘᵢₜ is equal to or smaller than Pₘₐₓ (Pₗᵢₘᵢₜ≤Pₘₐₓ). Accordingly, when Pₗᵢₘᵢₜ is equal to or smaller than Pₘₐₓ (Pₗᵢₘᵢₜ≤Pₘₐₓ), the electronic device 200 may determine that it communicates with the base station (or cell) using an intermediate or high frequency band requiring the SAR backoff.

If it is determined that the SAR backoff is not required, the electronic device 200 may perform a subroutine according to the first operation mode in operation 430. The first operation mode 330 defines, e.g., an operation of not performing a sensor monitoring operation when it is predicted to meet the SAR standard. In this case, the electronic device 200 may reduce current consumption due to sensor monitoring. For example, if it is expected that in the first operation mode 330, communication is performed to meet the SAR standard during one time slot, the electronic device 330 may prevent and/or block the CP (e.g., the CP 213 of FIG. 2) from requesting sensor monitoring from the AP (e.g., the AP 211 of FIG. 2). In this case, since the AP 211 and/or one or more sensors (e.g., the sensor module 230 of FIG. 2) are not required to wake up for sensor monitoring, current consumption due to sensor monitoring may be reduced.

If it is determined that the SAR backoff is required, the electronic device 200 may perform a subroutine according to the second operation mode in operation 440. The second operation mode 340 defines e.g., an operation that allows sensor monitoring to be performed when it is predicted that the SAR standard is not met. The electronic device 200 may consume a certain amount of current to perform sensor monitoring. For example, the electronic device 200 may allow the CP 213 to request sensor monitoring from the AP 211 in the second operation mode 340. In this case, the AP 211 may wake up for sensor monitoring and activate one or more sensors for sensor monitoring. The activated one or more sensors may transfer a monitoring result for the state change to the AP 211. The AP 211 may collect the monitoring result for the state change and transfer the monitoring result to the CP 213. In this case, current consumption for waking up the AP 211 and activating one or more sensors may occur. A few mA of current may be periodically consumed, e.g., to keep the AP 211 awake and, to keep the AP 211 awake and perform state change monitoring by the sensor (e.g., the sensor module 230 of FIG. 2), tens to hundreds of mA may be periodically consumed.

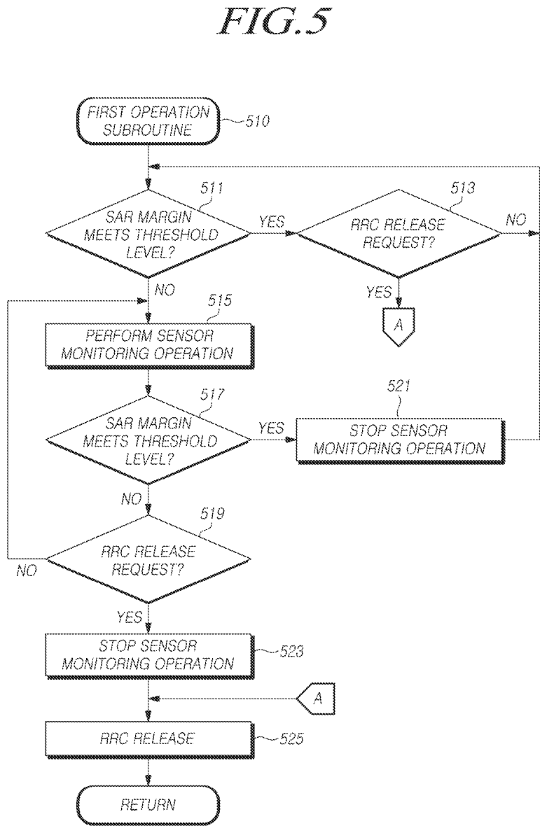

FIG. 5 is a flowchart illustrating an example subroutine for an operation (e.g., operation 430 of FIG. 4) in a frequency band not requiring SAR backoff in an electronic device (e.g., the electronic device 200 of FIG. 2) according to various embodiments.

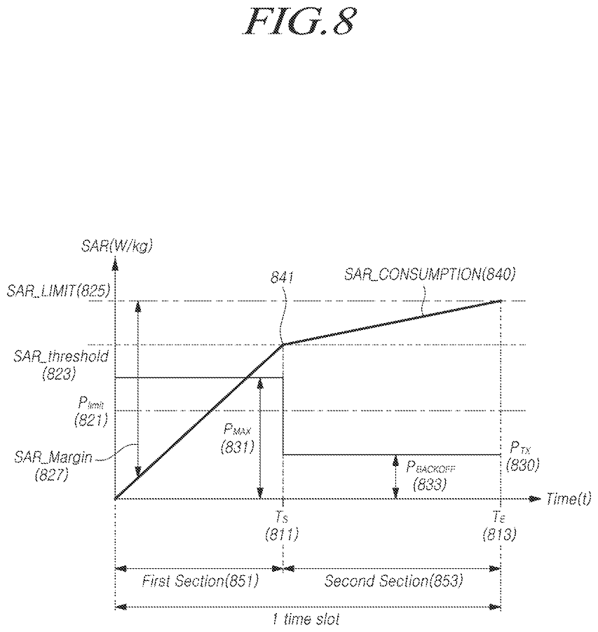

Referring to FIG. 5, the electronic device 200 may start a first operation subroutine (e.g., operation 430 of FIG. 4) in operation 510. In operation 511, the electronic device 200 may determine whether the SAR margin meets a threshold level. When the SAR margin meets the threshold level, it may be predicted that the SAR margin is roomy. In an embodiment, when the SAR margin (SAR_Margin) (e.g., the SAR_Margin 827 of FIG. 8) exceeds the threshold level (SAR_threshold), the electronic device 200 may determine that the SAR margin is sufficient or roomy. In an embodiment, if the SAR margin (SAR_Margin 827) is equal to or smaller than the threshold level (SAR_threshold), the electronic device 200 may determine that the SAR margin is not sufficient or roomy. The threshold level may be preset, e.g., as 70% or more of the total SAR (e.g., SAR_LIMIT 825 of FIG. 8).

If it is determined that the SAR margin is sufficient or roomy, the electronic device 200 may determine whether an event requesting RRC release has occurred in operation 513. The event requesting RRC release may include, e.g., an event, such as no work for a certain period of time or data blocking. If an RRC release event occurs, the electronic device 200 may release the RRC connection using an RRC message in operation 525. If an RRC release event does not occur, the electronic device 200 may repeat operations 511 and 513. In operations 511 and 513, as the operation for sensor monitoring is not activated, the sensor monitoring operation may not be substantially performed. The sensor monitoring operation may include, e.g., an operation in which the CP (e.g., the CP 213 of FIG. 2) transmits a message (SAR Event Request) requesting sensor monitoring to the AP (e.g., the AP 211 of FIG. 2). When the sensor monitoring operation is not substantially performed, it may refer, for example, to the operation in which the CP 213 transmits a message (SAR Event Request) requesting sensor monitoring to the AP 211 not being performed. Accordingly, if the SAR margin meets the threshold level, the electronic device 200 may not perform a sensor monitoring operation until the RRC connection is released. This may save the electronic device 200 from current consumption for performing sensor monitoring.

If it is determined that the SAR margin is not sufficient or roomy, the electronic device 200 may perform the sensor monitoring operation in operation 515. For example, in the sensor monitoring operation, the CP 213 may transmit a request message (SAR Event Request) requesting to monitor the sensor state to the AP 211 through the radio interface layer (RIL) to wake up the AP 211. When receiving the request message (SAR Event Request), the AP 211 may activate (sensor enable) one or more sensors (e.g., the sensor module 230 of FIG. 2) to periodically monitor the sensor state and transfer information regarding the sensor state to the CP 213. The CP 213 may obtain the device state index (DSI) from the information regarding the sensor state provided from to the obtained DSI. Pₗᵢₘᵢₜ may be a transmission power level matching a SAR design target.

Table 1 below illustrates examples of the threshold level and/or Pₗᵢₘᵢₜ preset for each DSI.

TABLE 1

| | | FREE | | | | GRIP | | | |
|---|---|---|---|---|---|---|---|---|---|
| | | 0 | | | | 1 | | | |
| | | | 2G/3G/ | | | | 2G/3G/ | | |
| | | | 4G/5G | TX | | | 4G/5G | TX | |
| | | | FR1/FR2 | power | | | FR1/FR2 | power | |
| | | | backoff | at | | | backoff | at | |
| | | | for | Design | | | for | Design | |
| | DSI | force | Wifi/BT | Target | | force | Wifi/BT | Target | |
| Tech_Band | Antenna | peak | (dB) | (dBm) | Threshold | peak | (dB) | (dBm) | Threshold |
| LTE_B1 | 11 | | | 27 | n % | | | 27 | n % |
| LTE_B1 | 0 | | | 20 | n % | | | 20 | n % |
| LTE_B12 | 0 | | | 28 | n % | | | 28 | n % |
| LTE_B13 | 0 | | | 28 | n % | | | 28 | n % |
| LTE_B14 | 0 | | | 28.1 | n % | | | 28.1 | n % |
| LTE_B18 | 0 | | | 27 | n % | | | 27 | n % |
| LTE_B19 | 0 | | | 27 | n % | | | 27 | n % |
| LTE_B2 | 11 | | | 19 | n % | | | 19 | n % |
| LTE_B2 | 0 | | | 20.5 | n % | | | 20.5 | n % |
| LTE_B20 | 0 | | | 27 | n % | | | 27 | n % |
| LTE_B25 | 11 | | | 19 | n % | | | 19 | n % |
| LTE_B25 | 0 | | | 20.5 | n % | | | 20.5 | n % |
| LTE_B26 | 0 | | | 27.6 | n % | | | 27.6 | n % |
| LTE_B28 | 0 | | | 27 | n % | | | 27 | n % |
| LTE_B3 | 11 | | | 18 | n % | | | 18 | n % |
| LTE_B3 | 0 | | | 19 | n % | | | 19 | n % |
| LTE_B30 | 11 | | | 16 | n % | | | 18 | n % |
| LTE_B30 | 0 | | | 21.5 | n % | | | 21.5 | n % |
| LTE_B38 | 11 | | | 19 | n % | | | 19 | n % |

| | HEAD | | | | HOT SPOT | | | |
|---|---|---|---|---|---|---|---|---|
| | 2 | | | | 3 | | | |
| | | 2G/3G/ | | | | 2G/3G/ | | |
| | | 4G/5G | TX | | | 4G/5G | TX | |
| | | FR1/FR2 | power | | | FR1/FR2 | power | |
| | | backoff | at | | | backoff | at | |
| | | for | Design | | | for | Design | |
| | force | Wifi/BT | Target | | force | Wifi/BT | Target | |
| Tech_Band | peak | (dB) | (dBm) | Threshold | peak | (dB) | (dBm) | Threshold |
| LTE_B1 | | | 21 | n % | | | 21 | n % |
| LTE_B1 | | | 27 | n % | | | 20 | n % |
| LTE_B12 | | | 33 | n % | | | 28.8 | n % |
| LTE_B13 | | | 31.9 | n % | | | 27 | n % |
| LTE_B14 | | | 31.5 | n % | | | 26.5 | n % |
| LTE_B18 | | | 27 | n % | | | 27 | n % |
| LTE_B19 | | | 27 | n % | | | 27 | n % |
| LTE_B2 | | | 18 | n % | | | 19 | n % |
| LTE_B2 | | | 33.5 | n % | | | 17.5 | n % |
| LTE_B20 | | | 27 | n % | | | 27 | n % |
| LTE_B25 | | | 18 | n % | | | 19 | n % |
| LTE_B25 | | | 33.5 | n % | | | 17.5 | n % |
| LTE_B26 | | | 29.5 | n % | | | 26.1 | n % |
| LTE_B28 | | | 27 | n % | | | 27 | n % |
| LTE_B3 | | | 18 | n % | | | 18 | n % |
| LTE_B3 | | | 27 | n % | | | 19 | n % |
| LTE_B30 | | | 18 | n % | | | 18 | n % |
| LTE_B30 | | | 36.8 | n % | | | 18.5 | n % |
| LTE_B38 | | | 18 | n % | | | 19 | n % |

In Table 1 above, Pₗᵢₘᵢₜ defining the SAR backoff power is set. In Table 1 above, Pₗᵢₘᵢₜ to be applied for each DSI is set. For example, in an intermediate frequency band and/or high frequency band in the FDD scheme, the SAR value in the grip and/or hot spot DSI condition is high, so that Pₗᵢₘᵢₜ may be set to be low. However, in a low frequency band, the SAR margin is sufficient, so that Pₗᵢₘᵢₜ may be set to be high. For example, Pₗᵢₘᵢₜ may have a value higher than Pₘₐₓ. For example, in a frequency band corresponding to LTE_B1, LTE_B2, LTE_B3, LTE_B4, LTE_B7, LTE_B25, LTE_B30, LTE_B38, LTE_B40, LTE_B41, LTE_B66 or LTE_B48 in Table 1, Pₗᵢₘᵢₜ is set to be low as compared with the free condition. This may refer, for example, to the SAR value being high so that sensor triggering is required for sensor monitoring.

In Table 1 above, the threshold level for identifying the SAR margin may be set to a specific value for each frequency band. The set specific value may be defined as N % of the SAR value to meet the design target SAR value. The value corresponding to the threshold level may be registered as a memory table in the memory (e.g., memory 130 of FIG. 1), or may be included in the non-volatile (NV) structure of the electronic device 200, or be included in a specific area of software code (SW code).

In operation 517, the electronic device 200 may determine whether the SAR margin meets a threshold level. The threshold level may be, e.g., a threshold level determined through the sensor monitoring operation in operation 515. When the SAR margin meets the threshold level, it may be predicted that the SAR margin is roomy in the frequency band being used. In an embodiment, when the SAR margin (SAR_Margin) (e.g., the SAR_Margin 827 of FIG. 8) exceeds the threshold level, the electronic device 200 may determine that the SAR margin is sufficient or roomy. In an embodiment, if the SAR margin (SAR_Margin 827) is equal to or smaller than the threshold level, the electronic device 200 may determine that the SAR margin is not sufficient or roomy.

If the electronic device 200 determines that the SAR margin is sufficient or roomy, the electronic device 200 may stop the sensor monitoring operation in operation 521. If the sensor monitoring operation is stopped, the electronic device 200 may determine whether the SAR margin is roomy or the RRC connection is released without the sensor monitoring operation in operations 511 and 513.

If the electronic device 200 determines that the SAR margin is not sufficient or roomy, the electronic device 200 may determine whether an event requesting RRC release has occurred in operation 519. The event requesting RRC release may include, e.g., an event, such as no work for a certain period of time or data blocking. If an RRC release event does not occur, the electronic device 200 may return to operation 515 to continue the sensor monitoring operation.

If an RRC release event occurs, the electronic device 200 may stop the sensor monitoring operation in operation 523. The electronic device 200 may release the RRC connection using an RRC message in operation 525.

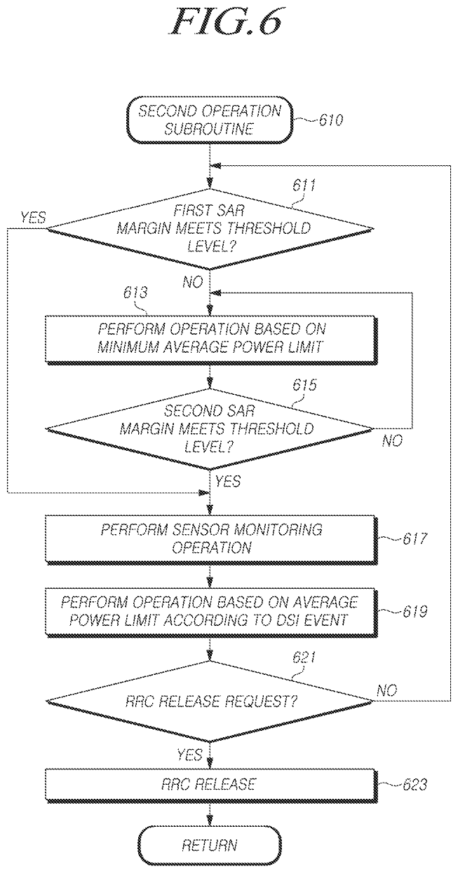

FIG. 6 is a flowchart illustrating an example subroutine for an operation (e.g., operation 440 of FIG. 4) in a frequency band requiring SAR backoff in an electronic device (e.g., the electronic device 200 of FIG. 2) according to various embodiments.

Referring to FIG. 6, the electronic device 200 may start a second operation subroutine (e.g., operation 440 of FIG. 4) in operation 610. In operation 611, the electronic device 200 may determine whether the first SAR margin (e.g., 1st SAR_Margin) meets a first threshold level (1st Threshold) (e.g., 70% of the total SAR margin). For example, the electronic device 200 may determine that SAR backoff is required, start a second operation subroutine 440, and then continue to identify the first SAR margin. The electronic device 200 may monitor whether the first SAR margin falls below the first threshold level (1^{st} SAR_Margin<1^{st} Threshold). If the first SAR margin falls below the first threshold level (1^{st} SAR_Margin<1^{st} Threshold), the electronic device 200 may determine that the first SAR margin does not meet the first threshold level. Failure of the first SAR margin to meet the first threshold level may be, e.g., an indicator indicating that the SAR margin is insufficient. If the first SAR margin is larger than or equal to the first threshold level (1^{st} SAR_Margin>1^{st} Threshold), the electronic device 200 may determine that the first SAR margin meets the first threshold level. That the first SAR margin meets the first threshold level may be, e.g., an indicator indicating that the SAR margin is sufficient or roomy.

When determining that the first SAR margin meets the first threshold level, the electronic device 200 may perform an operation for SAR management based on the minimum average power limit (min.Pₗᵢₘᵢₜ) during the SAR event in operation 613. For example, even when operating based on the minimum average power limit (min.Pₗᵢₘᵢₜ) during the SAR event, the electronic device 200 may continue to identify the second SAR margin (e.g., 2^{nd} SAR_Margin).

In operation 615, the electronic device 200 may determine whether the second SAR margin (e.g., 2^{nd} SAR_Margin) meets a second threshold level (2^{st} Threshold). The electronic device 200 may monitor whether the second SAR margin falls below the second threshold level (2^{nd} SAR_Margin<2^{nd} Threshold). If the second SAR margin falls below the second threshold level (2^{nd} SAR_Margin<2^{nd} Threshold), the electronic device 200 may determine that the second SAR margin does not meet the second threshold level. Failure of the second SAR margin to meet the second threshold level may be, e.g., an indicator indicating that the SAR margin is insufficient. If the second SAR margin is larger than or equal to the second threshold level (2^{nd} SAR Margin≥2^{nd} Threshold), the electronic device 200 may determine that the second SAR margin meets the second threshold level. That the second SAR margin meets the second threshold level may be, e.g., an indicator indicating that the SAR margin is sufficient or roomy. If the second SAR margin is equal to or larger than the second threshold level (2^{nd} SAR_Margin≥2^{nd} Threshold), the electronic device 200 may determine that the SAR margin is sufficient or roomy and thus may continuously stopping transmitting a request mg (SAR Event Request) to the AP 211.

If the first SAR margin does not meet the first threshold level or the second SAR margin does not meet the second threshold level, the electronic device 200 may perform a sensor monitoring operation in operation 617. For example, in the sensor monitoring operation, the CP 213 may transmit a request message (SAR Event Request) requesting to monitor the sensor state to the AP 211 through the RIL to wake up the AP 211. When receiving the request message (SAR

Event Request), the AP 211 may activate (sensor enable) one or more sensors (e.g., the sensor module 230 of FIG. 2) to periodically monitor the sensor state. The AP 211 may transfer information about the sensor state to the CP 213 using the monitoring results. The CP 213 may obtain the device state index (DSI) from the information regarding the sensor state provided from to the obtained DSI. The determination of the threshold level and/or Pₗᵢₘᵢₜ corresponding to the obtained DSI may be performed like operation 515 of FIG. 5.

In operation 619, the electronic device 200 may perform SAR margin management based on the average power limit (Pₗᵢₘᵢₜ) and/or threshold level according to the DSI event. The electronic device 200 may adjust the speed at which the SAR margin decreases, e.g., by controlling transmission power. For example, when decreasing the transmission power, the speed at which the SAR margin decreases may be reduced.

In operation 621, the electronic device 200 may determine whether an event requesting RRC release occurs. The event requesting RRC release may include, e.g., an event, such as no work for a certain period of time or data blocking. If an RRC release event occurs, the electronic device 200 may release the RRC connection using an RRC message in operation 623. If an RRC release event does not occur, the electronic device 200 may repeat operations 611 to 619.

In the above description, the sensor monitoring operation may include, e.g., an operation in which the CP 213 transmits a message (SAR Event Request) requesting sensor monitoring to the AP 211. When the sensor monitoring operation is not substantially performed, it may refer, for example, to the operation in which the CP 213 transmits a message (SAR Event Request) requesting sensor monitoring to the AP 211 not being performed. Accordingly, if the SAR margin meets the threshold level, the electronic device 200 may not perform a sensor monitoring operation until the RRC connection is released. This may save the electronic device 200 from current consumption for performing sensor monitoring.

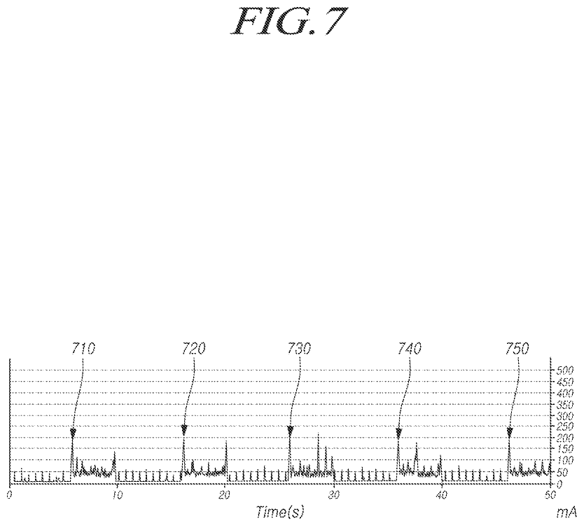

FIG. 7 is a graph illustrating a current amount consumed to perform periodic sensor monitoring in an electronic device (e.g., the electronic device 200 of FIG. 2) according to various embodiments.

Referring to FIG. 7, in an embodiment, if an RRC connection with the counterpart device (e.g., base station) is established, and a preset condition (e.g., when SAR backoff is required, and SAR margin is not sufficient) is met, the electronic device 200 may perform monitoring on the sensor. In this case, the electronic device 200 may cause periodic current consumption 710, 720, 730, 740, and 750 by an AP (e.g., the main processor 121 of FIG. 1 or the AP 211 of FIG. 2) and/or a sensor (e.g., the sensor module 230 of FIG. 2) for monitoring on the sensor.

In an embodiment, if a preset condition is not met after RRC connection is established (e.g., when it is determined that SAR backoff is not required or when it is determined that SAR backoff is required but SAR margin is sufficient), the electronic device 200 may not perform monitoring on the sensor. In this case, the electronic device 200 may save current consumption to perform monitoring on the sensor.

FIG. 8 is a graph illustrating a relationship between parameters for managing a SAR margin in an electronic device (e.g., the electronic device 200 of FIG. 2) according to various embodiments.

Referring to FIG. 8, in an embodiment, it is assumed that the electronic device 200 performs communication using the maximum transmission power (P_{MAX}) 831 from the start time of one time slot in the RRC connected state. In this case, the cumulative SAR (SAR_CONSUMPTION) 840 due to communication using the maximum transmission power (P_{MAX}) 831 over time may increase. The cumulative SAR (SAR_CONSUMPTION) 840 will reach a predesignated threshold level (SAR_threshold) 823 at a specific time (Tₛ) 811 when a time corresponding to a first section 851 elapses. The first section 851 may be a time section when the electronic device 200 performs communication using the maximum transmission power (P_{MAX}) 831. In the first section 851, SAR_Margin 827 may decrease in proportion to the cumulative SAR (SAR_CONSUMPTION) 840 over time. For example, the SAR_Margin 827 may be defined as “SAR_LIMIT (825)-SAR_CONSUMPTION (840)”. Here, the SAR_LIMIT 825 may be the total SAR set so that the electronic device 200 meets the SAR standard in one time slot. For example, the electronic device 200 may meet the SAR standard when the transmission power (PTX) 830 is allocated by the transmission power limit level (Pₗᵢₘᵢₜ) 821 which is the transmission power level matching the SAR design target during one time slot.

In an embodiment, if the cumulative SAR (SAR_CONSUMPTION) 840 reaches (841) a predesignated threshold level (SAR_threshold) 823, the electronic device 200 may determine that SAR backoff is required. As a result, the electronic device 200 may perform an SAR backoff operation in a second section 853 defined as when one time slot ends (T_{E}) 813 from the event occurrence time (T_{S}). The SAR backoff operation may be, e.g., an operation of controlling the transmission power (P_{TX}) 830 as the backoff power (P_{BACKOFF}) 833 to reduce the decrease rate of the SAR margin (SAR_Margin) 827. To that end, the electronic device 200 may perform a sensor monitoring operation to apply Pₗᵢₘᵢₜ 821 and/or threshold level optimized for each DSI.

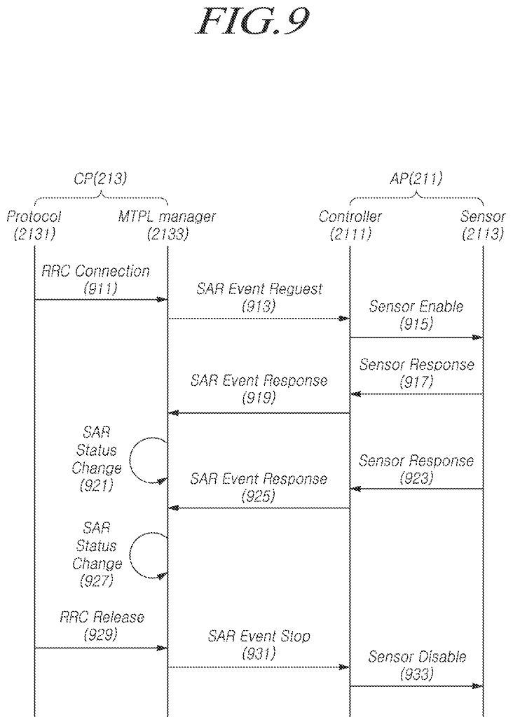

FIG. 9 is a signal flow diagram illustrating an example signal processing procedure for monitoring a sensor state in an electronic device (e.g., the electronic device 200 of FIG. 2) according to various embodiments.

Referring to FIG. 9, in an embodiment, the CP 213 (e.g., the auxiliary processor 123 of FIG. 1 or the CP 213 of FIG. 2) and the AP 211 (e.g., the main processor 121 of FIG. 1 or the AP 211 of FIG. 2) may exchange messages with each other through the RIL.

The CP 213 may establish an RRC connection with an electronic device (e.g., a base station) provided in a network (e.g., the second network 199 of FIG. 1) using a radio resource control (RRC) message. The RRC connection establishment may include an operation (e.g., RRC connection/SAR state activation 311 of FIG. 3) in which a state transition is performed from an RRC release state (e.g., RRC release state 310 of FIG. 3) to an RRC connected state (e.g., RRC connected state 320 of FIG. 3).

If the RRC connection is established, the CP 213 may be allocated uplink and/or downlink radio resources from the base station to monitor a control channel of the base station, transmit or receive data. If the RRC connection is established, the CP 213 may report various measurement information such as channel state, security management, and traffic management to the base station, or may perform a handover procedure considering channel state or traffic speed dominantly in the network 199. Therefore, that the RRC connection is established may refer, for example, to transmission power existing. When there is no work for a certain period of time or an event such as blocking data occurs, the CP 213 may reset or release the RRC connection using an RRC message. The release of the RRC connection may refer, for example, to there being no transmission power.

The CP 213 may include a protocol 2131 or a maximum transmission power level manager (MTPL) 2133. The protocol 2131 defines a rule agreed to perform wireless communication with the base station in the CP 213. The protocol 2131 may include an RRC protocol or an RRC layer. The RRC protocol or the RRC layer may be a protocol or layer for managing a connection between the electronic device 200 and the base station. The MTPL manager 2133 may manage an MTPL to be considered in order to control transmission power to meet the SAR standard in the CP 213.

According to an embodiment, when the RRC connection is established by the protocol 2131, the MTPL manager 2133 may selectively transmit a request message (SAR Event Request) requesting sensor monitoring to the AP 211 considering whether SAR backoff is required or SAR margin is sufficient. The MTPL manager 2133 may determine, e.g., whether SAR backoff is required based on the operating frequency band. The SAR request message (SAR Event Request) may be a message requesting sensor monitoring from the AP 211. When the request message (SAR Event Request) is not transmitted to the AP 211 by the MTPL manager 2133, the AP 211 may not wake up. In this case, current consumption for waking up the AP 211 may not occur.

The MTPL manager 2133 may determine that the SAR backoff is not required when it is predicted that the SAR standard may be met, even if it operates with the maximum transmission power that the electronic device 200 may use during one time slot using the operating frequency band. The MTPL manager 2133 may determine that the SAR backoff is not required when operating in a frequency band (e.g., a low frequency band) in which the minimum Pₗᵢₘᵢₜ (P_{limit.min}) among the Pₗᵢₘᵢₜ's for each DSI exceeds the maximum transmission power Pₘₐₓ (P_{limit.min}>Pₘₐₓ) that may be used while meeting the SAR standard in the electronic device 200. For example, when an RRC connection is established with a serving cell or a serving base station in a frequency band that meets a condition that does not require SAR backoff (P_{limit.min}>Pₘₐₓ), the MTPL manager 2133 may not transmit a request message (SAR Event Request) to the AP 211.

The MTPL manager 2133 may continuously identify the SAR margin even after determining that the SAR backoff is not required. If the SAR margin is larger than or equal to a threshold level (e.g., 70% of the total SAR margin), the MTPL manager 2133 may determine that the SAR margin is sufficient or roomy and may not continuously transmit the request message (SAR Event Request) to the AP 211. When the SAR margin falls below a threshold level, the MTPL manager 2133 may determine that the SAR margin needs to be managed to meet the SAR standard and transmit a request message (SAR Event Request) to the AP 211. The case where the SAR margin falls below the threshold level may correspond to, e.g., a case where the electronic device 200 performs handover in a serving cell or a serving base station in which SAR consumption is excessive.

The MTPL manager 2133 may determine that the SAR backoff is necessary if it is predicted that the SAR standard may not be met when the maximum transmission power available to the electronic device 200 is operated during one time slot using the operating frequency band. The MTPL manager 2133 may determine that the SAR backoff is required when operating in a frequency band (e.g., an intermediate frequency or high frequency band) in which the minimum Pₗᵢₘᵢₜ (P_{limit.min}) among the Pₗᵢₘᵢₜ's for each DSI is equal to or lower than the maximum transmission power Pₘₐₓ (P_{limit.min}≤Pₘₐₓ) that may be used while meeting the SAR standard in the electronic device 200.

The MTPL manager 2133 may continuously check the first SAR margin (e.g., 1^{st} SAR_Margin) after determining that the SAR backoff is necessary. When the first SAR margin falls below a first threshold level (1^{st} SAR_Margin<1^{st} Threshold), the MTPL manager 2133 may determine that the SAR margin needs to be managed to meet the SAR standard and transmit a request message (SAR Event Request) to the AP 211. The case where the first SAR margin falls below the first threshold level may correspond to, e.g., a case where SAR consumption in the electronic device 200 is excessive. If the first SAR margin is equal to or larger than the first threshold level (1^{st} Threshold) (e.g., 70% of the total SAR margin) (1^{st} SAR_Margin≥1^{st} Threshold), the MTPL manager 2133 may determine that the SAR margin is sufficient or roomy and thus may not transmit a request mg (SAR Event Request) to the AP 211. If the first SAR margin is equal to or larger than the first threshold level (1^{st} SAR_Margin≥1^{st} Threshold), the MTPL manager 2133 may operate based on the minimum average power limit (min.Pₗᵢₘᵢₜ) during the SAR event. Even when operating based on the minimum average power limit (min.Pₗᵢₘᵢₜ) during the SAR event, the MTPL manager 2133 may continuously identify the second SAR margin (e.g., 2^{nd} SAR_Margin). If the second SAR margin is equal to or larger than the second threshold level (2^{nd} Threshold)(2^{nd} SAR_Margin≥2^{nd} Threshold), the MTPL manager 2133 may determine that the SAR margin is sufficient or roomy and thus may continuously stop transmitting a request mg (SAR Event Request) to the AP 211. When the second SAR margin falls below a second threshold level (2^{nd} SAR_Margin<2^{nd} Threshold), the MTPL manager 2133 may determine that the SAR margin needs to be managed to meet the SAR standard and transmit a request message (SAR Event Request) to the AP 211. The case where the second SAR margin falls below the second threshold level may correspond to, e.g., a case where SAR consumption in the electronic device 200 is excessive.

As described above, when determining that in the RRC connected state (e.g., the RRC connected state 320 of FIG. 3), SAR backoff is not required or SAR backoff is required but SAR margin is sufficient, the MTPL manager 2133 may not transmit a request message (SAR Event Request) for waking up the AP 211 to the AP 211. When the request message (SAR Event Request) is not transmitted to the AP 211 by the MTPL manager 2133, the AP 211 may not wake up. In this case, current consumption for waking up the AP 211 may not occur.

The MTPL manager 2133 may receive a response message (SAR Event Response) including information about the sensor state from the AP 211 in response to a request message (SAR Event Request). The MTPL manager 2133 may change the SAR state based on the sensor state information (DSI) included in the received response message (SAR Event Response). The sensor state information (DSI) may be, e.g., sensing information about a sensor related to a USB, grip, proxy, or near, or information about a state change of a device such as an LCD. The information about the state change of the USB may be sensing information indicating a state of whether a cable for charging or data sharing is mounted on the USB port. The information about the state change of the grip may be sensing information sensed by the grip sensor according to whether the user grips the electronic device 200 and/or the form of the gripping hand. The information about the state change of the proxy may be sensing information about the change in an operating subject performing a specific function. The information about the state change of proximity may be sensing information sensed by a proximity sensor due to an interval between the electronic device 200 gripped by the user and the body. The information about the state change of the LCD may be information indicating the operation state of the display. The information indicating the operation state of the display may include, e.g., information indicating a power saving state such as a screen off or a minimum activation state (e.g., always on display (AOD)). The change in the SAR state may be, e.g., a change of MTPL.

The AP 211 wakes up at the request of the CP 213 (SAR Event Request) and activates one or more sensors 2113 to periodically monitor the sensor response. The AP 211 may transfer sensor state information (DSI) obtained through periodic monitoring to the CP 213. The AP 211 may disable the sensor 2113 by a stop request (SAR Event Stop) from the CP 213 to stop the operation of monitoring the sensor state.

The AP 211 may include a controller 2111 or one or more sensors 2113. The one or more sensors 2113 may be provided as separate components, rather than being included in the AP 211, such as, e.g., the sensor module 230 shown in FIG. 2.

For example, the protocol 2131 executed on the CP 213, if an RRC connection is established, may send a notification (RRC Connection) indicating that the RRC connection has been established to the MTPL manager 2133 (operation 911). If the establishment of the RRC connection is notified, the MTPL manager 2133 may transmit a request message (SAR Event Request) requesting to monitor and report the sensor state to the controller 2111 of the AP 211 through the RIL considering whether SAR backoff is required or SAR margin is sufficient. The determination of whether the MTPL manager 2133 transmits the request message (SAR Event Request) has been described above, and no specific description thereof is thus given.

When receiving the request message (SAR Event Request) from the MTPL manager 2133 of the CP 213, the controller 2111 of the AP 211 may activate the sensor 2113 and transfer a sensor enable (Sensor Enable) signal requesting to report the sensor state to the sensor 2113 (operation 915). If the sensor enable signal is received, the sensor 2113 may be activated and, when an event such as a state change occurs, transfer sensor monitoring information thereabout to the controller 2111 through a response message (Sensor Response) (operation 917). The event such as s state change may include, e.g., mounting of the cable to the USB port for charging or data sharing, a change in whether the user grips the electronic device 200 and/or the shape of the hand grip, a change of the operating subject performing a specific function, a change in the distance between the electronic device 200 gripped by the user and the user's body, or operating in power saving state such as minimum activation state (e.g., always on display (AOD)) or screen-off. The controller 2111 of the AP 211 may compile or collect the sensor monitoring information received from one or more sensors 2113 and transmit the same to the MTPL manager 2133 of the CP 213 through a response message (SAR Event Response) (operation 919).

The MTPL manager 2133 of the CP 213 may obtain sensor monitoring information from the response message (SAR Event Response) received from the controller 2111 of the AP 211. The MTPL manager 2133 may identify the SAR state of a device such as each sensor (e.g., grip, proximity sensor, or touch panel) or display (e.g., LCD) considering, e.g., predesignated priority. The MTPL manager 2133 may change the MTPL based on the state information monitored from an activated sensor having the highest priority among the identified SAR states (operation 921).

After being activated, the sensor 2113 may transfer the sensor monitoring information to the controller 2111 through a response message (Sensor Response), periodically or whenever a state change occurs (operation 923). The controller 2111 of the AP 211 may compile or collect the sensor monitoring information received from one or more sensors 2113 and transmit the same to the MTPL manager 2133 of the CP 213 through a response message (SAR Event Response) (operation 925).

The MTPL manager 2133 of the CP 213 may obtain sensor monitoring information from the response message (SAR Event Response) received from the controller 2111 of the AP 211. The MTPL manager 2133 may identify the SAR state of a device such as each sensor (e.g., grip, proximity sensor, or touch panel) or display (e.g., LCD) considering, e.g., predesignated priority. The MTPL manager 2133 may change the MTPL based on the state information monitored from an activated sensor having the highest priority among the identified SAR states (operation 927).

The protocol 2131 executed on the CP 213 may release the RRC connection when there is no work for a predetermined period of time or an event such as data blocking occurs, thereby transitioning from the RRC connected state (e.g., the RRC connected state 320 of FIG. 3) to the RRC release state (e.g., the RRC release state 310 of FIG. 3). If transitioning to the RRC release state 310, the protocol 2131 may notify (RRC Release) the MTPL manager 2133 that the RRC connection has been released (operation 929). If the RRC release is notified of, the MTPL manager 2133 may transmit a request message (SAR Event Stop) to request to stop monitoring the sensor state and reporting to the controller 2111 of the AP 211 (operation 931). If not receiving the sensor state from the controller 2111 of the AP 211, the MTPL manager 2133 may not transmit the request message (SAR Event Stop).

When receiving the request message (SAR Event Stop) from the MTPL manager 2133 of the CP 213, the controller 2111 of the AP 211 may deactivate the sensor 2113 and transfer a sensor disable (Sensor disable) signal requesting to deactivate the sensor 2113 to stop reporting the sensor state to the sensor 2113 (operation 933). If receiving the sensor disable signal, the sensor 2113 may stop transferring the sensor monitoring information according to an event such as a state change to the controller 2111.

According to an embodiment, an electronic device (e.g., the electronic device 200 of FIG. 2) may include: a communication module comprising communication circuitry (e.g., the communication module 220 of FIG. 2) configured to perform wireless communication, a sensor module including at least one sensor (e.g., the sensor module 230 of FIG. 2) configured to detect a state related to the electronic device and generate sensor monitoring information corresponding to the detected state, and at least one processor, comprising processing circuitry (e.g., the processor 210 of FIG. 2), electrically connected to the communication module or the sensor module and configured to control power consumption in the electronic device.

According to an example embodiment, at least one processor included in the electronic device may individually and/or collectively be configured to stop the state identification on at least one sensor until a cumulative specific absorption rate (SAR) reaches a specified threshold (SAR_threshold) based on a radio resource control (RRC) connection with an external electronic device (e.g., the electronic device 104 of FIG. 1) being maintained by the communication module. The cumulative specific absorption rate may be a specific absorption rate accumulated by transmission power transmitted within a time interval corresponding to a time slot using a specific frequency band.

According to an example embodiment, at least one processor, individually and/or collectively, may be configured to initiate the state identification for the at least one sensor based on the cumulative specific absorption rate reaching the specified threshold (SAR_threshold) based on the radio resource control (RRC) connection being maintained.

According to an example embodiment, at least one processor, individually and/or collectively, may be configured to not initiate the state identification for the at least one sensor based on a consumable margin specific absorption rate (SAR) meeting an effective level although the cumulative specific absorption rate reaches the specified threshold (SAR_threshold).

According to an example embodiment, in the electronic device, a first processor, including processing circuitry (e.g., the CP 213 of FIG. 2,), configured to control the transmission power may be included in the at least one processor and may be configured to wake up a second processor (e.g., the AP 211 of FIG. 2) controlling the at least one sensor to request to identify a state for the at least one sensor.

According to an example embodiment, in the electronic device, based on a first specific absorption rate margin being a first threshold or more, based on a second specific absorption rate margin being less than a second threshold based on operating based on a lowest average power limit, a first processor included in the at least one processor to control the transmission power may be configured to wake up a second processor included in the at least one processor and configured to control at least one sensor to request to identify a state for the at least one sensor.

According to an example embodiment, in the electronic device, the second processor may be configured to obtain sensing information through the state identification for the at least one sensor and transfer the sensing information to the first processor.

According to an example embodiment, in the electronic device, the first processor may be configured to obtain a power limit level (Pₗᵢₘᵢₜ) indicated by a device state index included in the sensing information and control the transmission power by the obtained power limit level (Pₗᵢₘᵢₜ), and based on the radio resource control (RRC) connection being released, the first processor may be configured to instruct the second processor to stop the state identification for the at least one sensor.

According to an example embodiment, a method for controlling power consumption in an electronic device may include, based on a radio resource control (RRC) connection being maintained, stopping state identification for at least one sensor until a cumulative specific absorption rate (SAR) reaches a specified threshold (SAR_threshold) (e.g., operation 410 of FIG. 4, and operations 517 and 521 of FIG. 5). The cumulative specific absorption rate may be a specific absorption rate accumulated by transmission power transmitted within a time interval corresponding to a time slot using a specific frequency band.

According to an example embodiment, the method for controlling the power consumption in the electronic device may include initiating the state identification for the at least one sensor based on the cumulative specific absorption rate reaching the specified threshold (SAR_threshold) based on the radio resource control (RRC) connection being maintained (e.g., operation 931 of FIG. 9).

According to an example embodiment, the method for controlling the power consumption in the electronic device may include allowing a first processor controlling the transmission power to wake up a second processor controlling the at least one sensor to request to identify a state for the at least one sensor (e.g., operation 913 of FIG. 9).

According to an example embodiment, the method for controlling the power consumption in the electronic device may include, based on a first specific absorption rate margin being a first threshold or more, based on a second specific absorption rate margin being less than a second threshold based on operating based on a lowest average power limit, allowing a first processor controlling the transmission power to wake up a second processor controlling the at least one sensor to request to identify a state for the at least one sensor (e.g., operation 913 of FIG. 9).

According to an example embodiment, the method for controlling the power consumption in the electronic device may include allowing the second processor to obtain sensing information through the state identification for the at least one sensor and allowing the second processor to transfer the sensing information to the first processor (e.g., operation 919 and operation 925 of FIG. 9).

According to an example embodiment, the method for controlling the power consumption in the electronic device may include allowing the first processor to obtain a power limit level (Pₗᵢₘᵢₜ) indicated by a device state index included in the sensing information and controlling the transmission power by the obtained power limit level (Pₗᵢₘᵢₜ) (e.g., operation 921 and operation 929 of FIG. 9).

According to an example embodiment, the method for controlling the power consumption in the electronic device may include, based on the radio resource control (RRC) connection being released, allowing the first processor to instruct the second processor to stop the state identification for the at least one sensor (e.g., operation 931 of FIG. 9).

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is accessible by a machine (e.g., the electronic device 101 or the electronic device 200). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™M), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a communication module comprising communication circuitry configured to perform wireless communication;
a sensor module including at least one sensor configured to detect a state related to the electronic device and generate sensor monitoring information corresponding to the detected state; and
at least one processor, comprising processing circuitry, electrically connected to the communication module and/or the sensor module to control power consumption in the electronic device,
wherein at least one processor, individually and/or collectively, is configured to, based on a radio resource control (RRC) connection with an external electronic device being maintained by the communication module, stop state identification for at least one sensor until a cumulative specific absorption rate (SAR) reaches a specified threshold, and
wherein the cumulative specific absorption rate is a specific absorption rate accumulated by transmission power transmitted within a time interval corresponding to a time slot using a specific frequency band.

2. The electronic device of claim 1, wherein at least one processor, individually and/or collectively, is configured to initiate the state identification for the at least one sensor at a time based on the cumulative specific absorption rate reaching the specified threshold based on the radio resource control (RRC) connection being maintained.

3. The electronic device of claim 2, wherein at least one processor, individually and/or collectively, is configured to not initiate the state identification for the at least one sensor based on a consumable margin specific absorption rate (SAR) meeting an effective level although the cumulative specific absorption rate reaches the specified threshold.

4. The electronic device of claim 2, wherein a first processor, comprising processing circuitry, and configured to control the transmission power is included in the at least one processor and is configured to wake up a second processor, comprising processing circuitry, configured to control the at least one sensor to request to identify a state for the at least one sensor.

5. The electronic device of claim 1, wherein based on a first specific absorption rate margin being a first threshold or more, based on a second specific absorption rate margin being less than a second threshold based on operating based on a lowest average power limit, a first processor, comprising processing circuitry, included in the at least one processor and configured to control the transmission power is configured to wake up a second processor, comprising processing circuitry, included in the at least one processor and configured to control the at least one sensor to request identification of a state for the at least one sensor.

6. The electronic device of claim 4, wherein the second processor, individually and/or collectively, is configured to obtain sensing information through the state identification for the at least one sensor and transfer the sensing information to the first processor.

7. The electronic device of claim 6, wherein the first processor is configured to obtain a power limit level (Pₗᵢₘᵢₜ) indicated by a device state index included in the sensing information and control the transmission power by the obtained power limit level (Pₗᵢₘᵢₜ); and
wherein based on the radio resource control (RRC) connection being released, the first processor is configured to instruct the second processor to stop the state identification for the at least one sensor.

8. A method for controlling power consumption in an electronic device, the method comprising, based on a radio resource control (RRC) connection being maintained, stopping state identification for at least one sensor until a cumulative specific absorption rate (SAR) reaches a specified threshold,
wherein the cumulative specific absorption rate is a specific absorption rate accumulated by transmission power transmitted within a time interval corresponding to a time slot using a specific frequency band.

9. The method of claim 8, further comprising initiating the state identification for the at least one sensor based on the cumulative specific absorption rate reaching the specified threshold based on the radio resource control (RRC) connection being maintained.

10. The method of claim 9, further comprising refraining from initiating the state identification for the at least one sensor based on a consumable margin specific absorption rate (SAR) meeting an effective level although the cumulative specific absorption rate reaches the specified threshold.

11. The method of claim 9, wherein initiating the state identification includes controlling, by a first processor, the transmission power to wake up a second processor controlling the at least one sensor to request to identify a state for the at least one sensor.

12. The method of claim 8, further comprising, based on a first specific absorption rate margin being a first threshold or more, based on a second specific absorption rate margin being less than a second threshold based on operating based on a lowest average power limit, performing, by a first processor controlling the transmission power, wake up of a second processor controlling the at least one sensor to request identification a state for the at least one sensor.

13. The method of claim 11, further comprising:
obtaining, by the second processor, sensing information through the state identification for the at least one sensor; and
transferring, by the second processor, to transfer the sensing information to the first processor.

14. The method of claim 13, further comprising:
obtaining, by the first processor, a power limit level (Pₗᵢₘᵢₜ) indicated by a device state index included in the sensing information; and
controlling the transmission power by the obtained power limit level (Pₗᵢₘᵢₜ).

15. The method of claim 13, further comprising, based on the radio resource control (RRC) connection being released, allowing the first processor to instruct the second processor to stop the state identification for the at least one sensor.

16. One or more non-transitory computer-readable storage media storing computer-executable instructions that, when executed by at least one processor individually or collectively, cause an electronic device to perform operations, the operations comprising:
based on a radio resource control (RRC) connection being maintained, stopping state identification for at least one sensor until a cumulative specific absorption rate (SAR) reaches a specified threshold,
wherein the cumulative specific absorption rate is a specific absorption rate accumulated by transmission power transmitted within a time interval corresponding to a time slot using a specific frequency band.

17. The one or more non-transitory computer-readable storage media of claim 16, further comprising initiating the state identification for the at least one sensor based on the cumulative specific absorption rate reaching the specified threshold based on the radio resource control (RRC) connection being maintained.

18. The one or more non-transitory computer-readable storage media of claim 17, further comprising refraining from initiating the state identification for the at least one sensor based on a consumable margin specific absorption rate (SAR) meeting an effective level although the cumulative specific absorption rate reaches the specified threshold.

19. The one or more non-transitory computer-readable storage media of claim 17, wherein initiating the state identification includes controlling, by a first processor, the transmission power to wake up a second processor controlling the at least one sensor to request to identify a state for the at least one sensor.

20. The one or more non-transitory computer-readable storage media of claim 16, further comprising, based on a first specific absorption rate margin being a first threshold or more, based on a second specific absorption rate margin being less than a second threshold based on operating based on a lowest average power limit, controlling, by a first processor, the transmission power to wake up a second processor controlling the at least one sensor to request identification a state for the at least one sensor.
